(19) United States
(12) Patent Application Publication
(10) Pub. No.: US 2014/0120265 A1
(43) Pub. Date: May 1, 2014

(54) SPRAY DEVICE AND NOZZLE FOR A SPRAY DEVICE

(71) Applicant: John Charles Larson, West Chester, PA (US)

(72) Inventor: John Charles Larson, West Chester, PA (US)

(21) Appl. No.: 14/005,235

(22) PCT Filed: Mar. 15, 2012
(86) PCT No.: PCT/US2012/029307

§ 371 Date: Jan. 6, 2014

Related U.S. Application Data
(60) Provisional application No. 61/452,666, filed on Mar. 15, 2011.

(51) Int. Cl. B05B 1/30

(52) U.S. Cl. CPC B05B 1/3013
USPC 427/372.2; 239/584; 427/421.1

(57) ABSTRACT

The present disclosure is directed to a nozzle for a liquid spraying device, such as a spray gun. This disclosure is particularly directed to a nozzle having a flow controller for modulating flow of the fluid during spraying. The nozzle can be used on a liquid device, such as a spray gun, for spray applications with improved flow controls. This disclosure is also directed to a liquid spray device comprising the nozzle disclosed herein.

### CROSS REFERENCE TO RELATED APPLICATION

The present disclosure is a U.S. National-Stage entry under 35 U.S.C. §371 based on International Application No. PCT/US2012/029307, filed Mar. 15, 2012 which was published under PCT Article 21(2) and which claims priority to U.S. Application No. 61/452,666, filed Mar. 15, 2011, which are all hereby incorporated in their entirety by reference.

### TECHNICAL FIELD

The technical field is directed to a nozzle for a liquid spraying device. This disclosure is particularly directed to a nozzle having a flow controller for modulating the flow of the fluid during spraying.

### BACKGROUND

Conventional spray devices, such as spray guns, can be used to spray liquids, such as coating compositions. Typically, a commercial spray gun utilizes a spray needle and nozzle combination wherein the spray needle can slide within the nozzle between a closed position and an open position. When the spray needle is at the open position, the nozzle can open and spray the liquid out of the spray gun. However, for some liquids, it is very challenging to control the flow rate using the commercial spray gun.

Accordingly, it is desirable to provide liquid spray devices for improving spray control.

In addition, other objects, desirable features and characteristics will become apparent from the subsequent summary and detailed description, and the appended claims, taken in conjunction with the accompanying drawings and this background.

### SUMMARY

In accordance with an exemplary embodiment, this disclosure is directed to a liquid spray device comprising:

i) a nozzle (1) comprising:
a) a tubular nozzle body having an orifice (3) at a first end of the tubular nozzle body with an orifice diameter (3a), an inside diameter (2b) and a longitudinal rotational axis along the tubular nozzle body; and
b) a flow controller positioned inside the tubular nozzle body proximal to the first end having a rotational axis in coaxial alignment with the orifice (3) along the longitudinal rotational axis, the flow controller comprising a circular body (6) and a spray channel (7) therethrough with a backend opening (8) distal to the orifice (3) and a forward opening (9) proximal to the orifice (3), wherein the spray channel is tapered along the rotational axis, in a tapering distance (11), from the backend opening (8) having a backend opening diameter (8a) to the forward opening (9) having a forward opening diameter (9a); and
ii) a spray needle (5) having a needle body with a seat diameter (5a) and a tapered needle tip (5′) with a maximum tip diameter equal to the seat diameter, the spray needle is assembled therethrough the tubular nozzle body and the spray channel and is slidable along the longitudinal rotational axis between a closed position and a fully open position; wherein, the backend opening diameter (8a) is greater than the seat diameter (5a) and smaller than the inside diameter (2b), and the forward opening diameter (9a) is greater than the orifice diameter (3a) and smaller than the backend opening diameter (8a), and the spray needle is configured to position at the closed position to close the orifice, at the fully open position to open the orifice and fully open the spray channel, or at a position between the closed position and the fully open position to open the orifice and partially open the spray channel.

In accordance with another exemplary embodiment, this disclosure is directed to a nozzle for a liquid spraying device, the nozzle comprising:

a) a tubular nozzle body having an orifice (3) at a first end of the tubular nozzle body with an orifice diameter (3a), an inside diameter (2b) and a longitudinal rotational axis along the tubular nozzle body; and
b) a flow controller positioned inside the tubular nozzle body proximal to the first end having a rotational axis in coaxial alignment with the orifice (3) along the longitudinal rotational axis, the flow controller comprising a circular body (6) and a spray channel (7) therethrough with a backend opening (8) distal to the orifice (3) and a forward opening (9) proximal to the orifice (3), wherein the spray channel is tapered along the rotational axis, in a tapering distance (11), from the backend opening (8) having a backend opening diameter (8a) to the forward opening (9) having a forward opening diameter (9a).

In accordance with a further exemplary embodiment, this disclosure is directed to method for producing a dry coating layer over a substrate with a coating composition, the method comprising the steps of:

A) providing the liquid spray device of this disclosure; and
B) spraying the coating composition with the spray device to form a wet coating layer over the substrate.

### BRIEF DESCRIPTION OF THE DRAWINGS

The various embodiments will hereinafter be described in conjunction with the following drawing figures, wherein like numerals denote like elements, and wherein:

FIG. 1 shows a side view of an exemplary embodiment of the nozzle of this disclosure.

FIG. 2 shows representative examples of cross-sectional side views of an exemplary embodiments of the nozzle having an add-on flow controller (A) and an exemplary embodiment of the nozzle having a built-in flow controller (B).

FIG. 3 shows representative examples of cross-sectional side views of an exemplary embodiment of an add-on flow controller (A), the flow controller with a spray needle positioned toward the orifice (B), and the flow controller with the spray needle positioned away from the orifice (C), wherein the orifice is not shown for clarity.

FIG. 4 shows representative examples of cross-sectional side views of an exemplary embodiment of the nozzle with the flow controller assembled within, wherein the spray needle is at the open position (A), or at the closed position (B).

FIG. 5 shows a representative schematic illustration of the nozzle assembled in a spray gun.

FIG. 6 shows data on spray flow rates, viscosity of coating samples, sizes of the flow controller's diameters, and the distance of spray needle movement represented by needle stop adjustment turns.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

The features and advantages of the various embodiments herein will be more readily understood, by those of ordinary skill in the art, from reading the following detailed description. It is to be appreciated that certain features, which are, for clarity, described above and below in the context of separate embodiments, may also be provided in combination in a single embodiment. Conversely, various features that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

The term “tapered”, “tapering” or “taper” means gradual change, such as gradual decrease in diameter or size from a starting point to an end point. Tapering can be linear or non-linear.

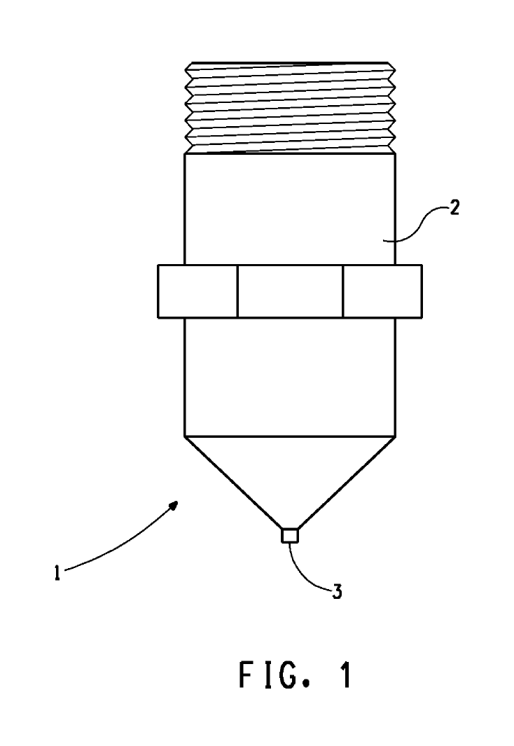

This disclosure is directed to a nozzle (1) (FIG. 1) for a liquid spraying device. In an exemplary embodiment, the liquid spraying device comprises:

i) a nozzle (1) comprising:
a) a tubular nozzle body having an orifice (3) at a first end of the tubular nozzle body with an orifice diameter (3a), an inside diameter (2b) and a longitudinal rotational axis along the tubular nozzle body; and
b) a flow controller positioned inside the tubular nozzle body proximal to the first end having a rotational axis in coaxial alignment with the orifice (3) along the longitudinal rotational axis, the flow controller comprising a circular body and a spray channel (7) therethrough with a backend opening (8) distal to the orifice (3) and a forward opening (9) proximal to the orifice (3), wherein the spray channel is tapered along the rotational axis, in a tapering distance (11), from the backend opening (8) having a backend opening diameter (8a) to the forward opening (9) having a forward opening diameter (9a); and
ii) a spray needle (5) having a needle body with a seat diameter (5a) and a tapered needle tip (5′) with a maximum tip diameter equal to the seat diameter. The spray needle is assembled therethrough the tubular nozzle body and the spray channel and is slidable along the longitudinal rotational axis between a closed position and a fully open position; wherein, the backend opening diameter (8a) is greater than the seat diameter (5a) and smaller than the inside diameter (2b), and the forward opening diameter (9a) is greater than the orifice diameter (3a) and smaller than the backend opening diameter (8a), and the spray needle is configured to position at the closed position to close the orifice, at the fully open position to open the orifice and fully open the spray channel, or at a position between the closed position and the fully open position to open the orifice and partially open the spray channel.

The seat diameter of the spray needle is the largest diameter of the portion of the spray needle that travels through the spray channel. In one example, the seat diameter is measured at the transition of the tapered needle tip to the needle body.

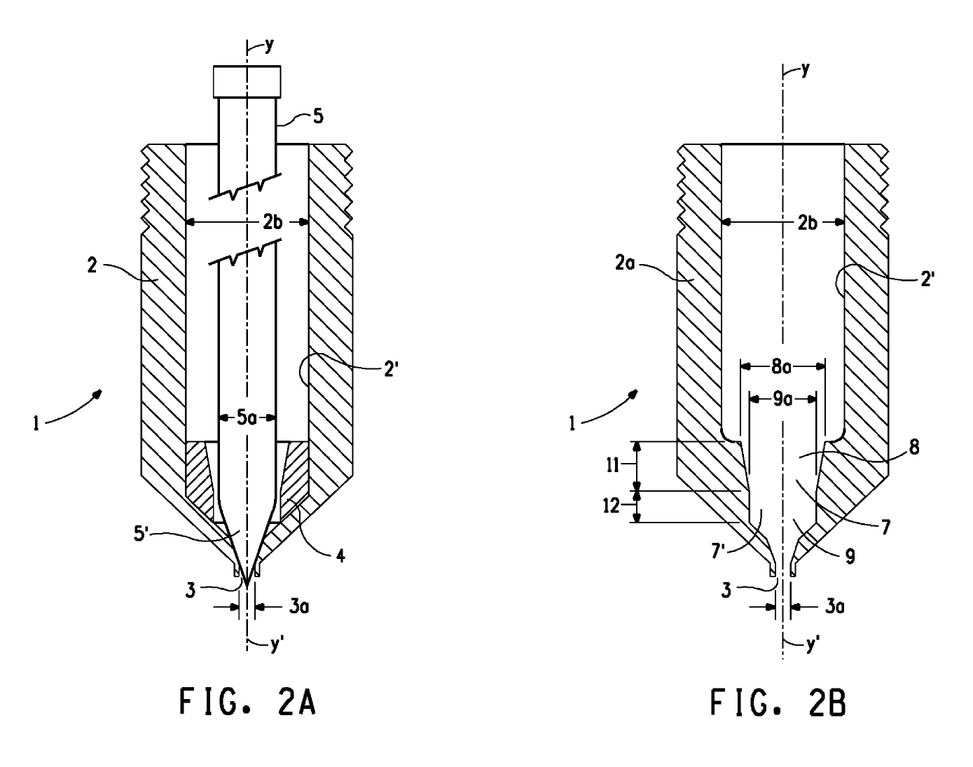

In an embodiment, the inside diameter (2b) (FIG. 2A and FIG. 2B) is the largest inside diameter measured inside the tubular nozzle body, for example the tubular nozzle body (2). Typically, the tubular nozzle body can have an open second end distal to the first end and the orifice (3). The second end can have screw threads or other types of adaptors, such as clipping, adaptor, or a combination thereof as known to those skilled in the art, either inside or outside of the tubular nozzle body. The nozzle (1) (FIG. 1) can fit onto the liquid spray device via the screw threads, or other types of the adaptors, for coupling with the body of the liquid spraying device, such as a spray gun. The tubular nozzle body can have further structures as determined appropriate by those skilled in the art. In one example, the tubular nozzle body can have screw thread outside the second end. In another example, the tubular nozzle body can have a hexagon structure outside the tubular body for easy handling with a tool, such as a wrench.

The liquid spraying device can be a spray gun known to or developed by those skilled in the art and can comprise a conventional spray nozzle suitable for spray operations. Typically, the liquid spraying device can have the spray needle (5) positioned within the device and the nozzle that can slide forward and backward to control the opening or closing of the nozzle. Typically, the nozzle and the spray needle are co-axially aligned, such as aligned to the longitudinal rotational axis y-y′ of the nozzle (FIG. 2A).

The flow controller can comprise a circular body (6) and a spray channel (7) therethrough. The flow controller can be an add-on flow controller (FIG. 2A) or a built-in flow controller (FIG. 2B) and positioned inside the nozzle (1), such as shown in representative examples (FIG. 2A and FIG. 2B). The spray channel can have a backend opening (8) and a forward opening (9). The spray channel (7) can be aligned co-axially with the orifice (3) and the spray needle (5).

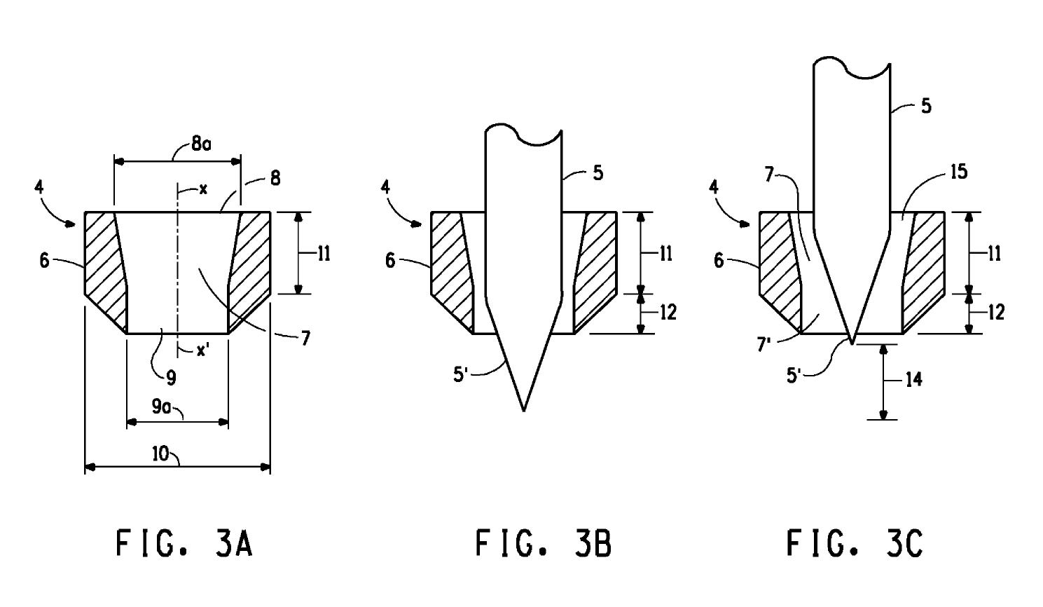

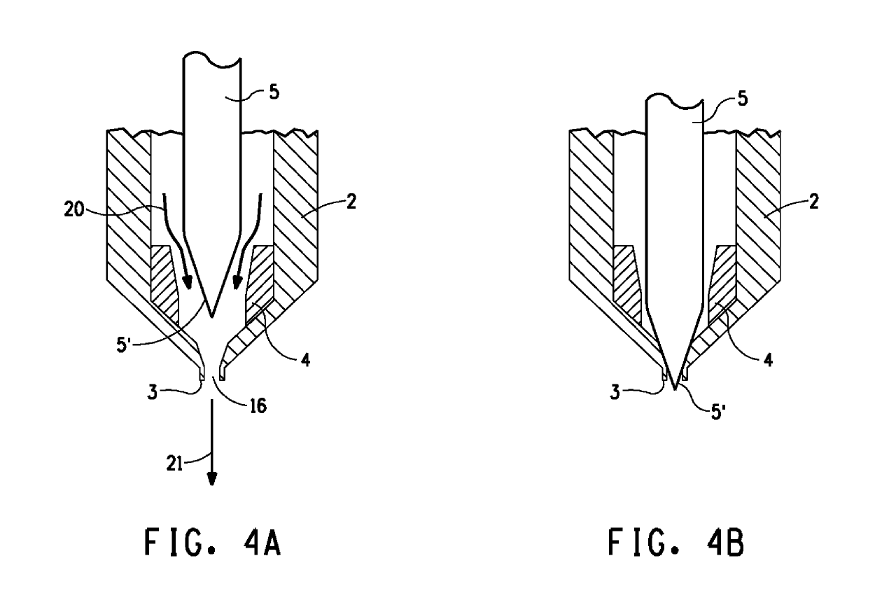

In an exemplary embodiment, the flow controller is an add-on flow controller machined to fit the inside of the tubular nozzle body at the first end and affixed to the inside of the tubular nozzle body. The add-on flow controller can comprise the circular body (6) and the spray channel (7) therethrough the circular body. In one example, the add-on flow controller (4) that can have a rotational axis x-x′ that can be co-axially aligned with the y-y′ axis, wherein the x-x′ axis can also be aligned the longitudinal rotational axis y-y′ (FIG. 2A and FIG. 3A). The add-on flow controller (4) can comprise the circular body (6) and the spray channel (7) therethrough, and can be machined to fit the inside geometry of the tubular nozzle body at the first end and affixed to the inside of the tubular nozzle body (FIG. 2A). In one example, the circular body (6) can be machined to have a body diameter (10) suitable for fitting into the tubular nozzle body and have the forward opening with geometry matching the inside geometry of the tubular nozzle body at the first end (FIG. 2A, FIG. 3A-3C, and FIG. 4A-4B). The add-on flow controller can be inserted into the tubular nozzle body from the second end of the tubular nozzle. Being “machined to fit” means that the circular body (6) of the flow controller (4) can fit and be liquid-tight between the circular body (6) and the internal surface (2′) of the tubular nozzle body at the first end, so no liquid can pass through between the circular body (6) and the internal surface (2′). All liquid, when present, must pass through the spray channel (7) when it is in an open position. In one example, the add-on flow controller (4) is machined to fit the shape and size of the inside of the tubular nozzle body so once affixed inside the tubular nozzle body, there is essentially no gap between the circular body (6) and the internal surface (2′). For example, the flow controller (4) can be machined to be slightly larger than the inside diameter (2b) of the tubular nozzle body and can be forced into the inside of the tubular nozzle body by conventional means such as hammering. In another example, the flow controller (4) can be machined to fit the shape of the inside of the tubular nozzle body at the first end, but slightly smaller than the inside diameter (2b) and one or more gaskets or sealers can be placed between the flow controller (4) and the internal surface (2′). When the inside of the tubular nozzle body is tapered towards the orifice, the flow controller (4) can also be machined to fit the tapering shape at the forward opening (9). The flow controller (4) can be affixed to the inside of the tubular nozzle body (1) at the first end by friction, by mechanical attachment such as soldering or screwing, clipping, or a combination thereof. Some examples are shown in FIG. 3A-3C. The spray channel can be tapered along the rotational axis, in the tapering distance (11), from the backend opening to the forward opening. The tapering distance is the shortest linear distance between the starting point and the end point of tapering. The spray channel can be tapered in a linear fashion starting from the backend opening having the backend opening diameter to the forward opening having the forward opening diameter. The add-on flow controller can have an extension channel (7′) having an extension channel diameter equal to the forward opening diameter and an extension channel length (12) and being co-axial with the spray channel. The spray channel (7), the extension channel (7′) and the orifice (3) are configured to be positioned at the first end inside of the tubular nozzle body (2 or 2a) with the extension channel (7′) positioned between the forward opening of the spray channel (7) and the orifice (3). The extension channel can have an extension channel length (12) in a range of from 10% to 120% of the tapering distance (11).

In another embodiment, the flow controller is a built-in flow controller with the circular body and the spray channel built in the tubular nozzle body. In one example, the circular body of the flow controller can be machined as a part of the tubular nozzle body, such as the tubular nozzle body (2a) (FIG. 2B), that can comprise the spray channel (7). The spray channel can be tapered along the rotational axis, in the tapering distance (11), from the backend opening to the forward opening. The built-in flow controller can also comprise the extension channel (7′) having an extension channel diameter equal to the forward opening diameter and the extension channel length (12) and being co-axial to the spray channel. The spray channel (7), the extension channel (7′) and the orifice (3) can be configured to be positioned at the first end inside of the tubular nozzle body (2a) with the extension channel (7′) positioned between the forward opening of the spray channel (7) and the orifice (3). The extension channel can have an extension channel length (12) in a range of from 10% to 120% of the tapering distance (11).

In an embodiment, the spray needle has a seat diameter in a range of from 5% to 70% of the inside diameter of the tubular nozzle body. The backend opening diameter can be in a range of from 110% of the seat diameter to 99% of the inside diameter and the forward opening diameter can be in a range of from 101% of the seat diameter to 99% of the backend opening diameter. In a further example, the backend opening diameter can be in a range of from 120% of the seat diameter to 99% of the inside diameter and the forward opening diameter can be in a range of from 101% of the seat diameter to 90% of the backend opening diameter. The forward opening (9) are configured to be larger than the orifice (3), meaning that the forward opening diameter (9a) is configured to be greater than the orifice diameter (3a).

The flow controller can be configured to have a maximum controller flow-through area (15) equal to or greater than the orifice flow-through area (16). The maximum controller flow-through area (15) is determined by the backend opening diameter and the spray needle at the fully open position, and the orifice flow-through area (16) is defined by the orifice diameter (3a) and the spray needle at the fully open position. In one example, the maximum controller flow-through area can be determined by a control flow-through space (15) (FIG. 3C) that is the space between the spray needle at the fully open position and the circular body of the flow controller at the backend opening. At the fully open position, flow rate of the liquid around the spray needle (20) should be equal to the flow rate of the liquid at the orifice (21) (FIG. 4A).

When the spray needle is positioned between the closed position and the fully open position, in an embodiment, the flow rate of the liquid around the spray needle (20) is restricted due to narrow the space (15) determined by the spray needle and the circular body of the flow controller. When the spray needle is positioned at the closed position, the orifice is closed.

With the flow controller of this disclosure, the liquid spray device can be configured to have a variable spray flow rate between zero when the spray needle is at the closed position through a maximum flow rate when said spray needle is at the fully open position. The variable spray flow rate is controlled by a needle positioning device that positions the spray needle at variable positions within a needle travel range (14). In an exemplary embodiment, the needle travel range is equal to the tapering distance (11).

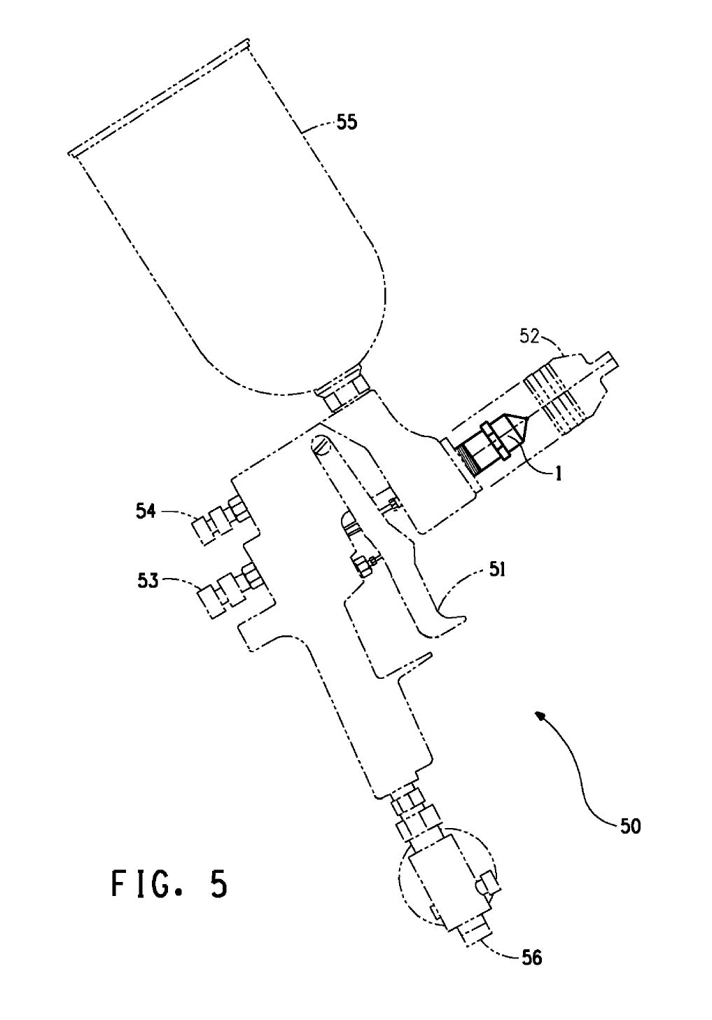

In another embodiment, the spray needle is coupled to a trigger mechanism of the liquid spray device to slide the spray needle within the needle travel range (14) between the closed position and the fully open position. The needle positioning device can comprise the trigger mechanism coupled to the spray needle, a needle adjustment device, or a combination thereof. In one example, the spray needle is coupled to a trigger mechanism (51) of a spray gun (50) (FIG. 5). An operator can manually control the trigger to control flow rate. In another example, the spray needle is coupled to a combination of a trigger mechanism (51) and a needle adjustment device (53). The needle adjustment device (53) can pre-set a maximum adjusted needle travel distance so when the trigger is fully pulled, the spray needle can stop at a pre-set position based on the pre-set maximum adjusted needle travel distance.

In a further embodiment, a liquid spraying device such as a spray gun (50) comprises a spray gun body that can have multiple parts, controls, couplings, etc., such as a spray needle, a trigger, one or more reservoirs (55) for holding one or more liquids to be sprayed, a carrier coupling (56) for coupling to a source of a carrier and measuring flow rate and pressure of the carrier, such as compressed air; a carrier regulator assembly (54) for regulating carrier delivered to the spray nozzle; an air cap (52); and/or other mechanisms or devices necessary for proper operation of a spray gun. Typically, multiple channels, connectors, connection paths and mechanical controls can be assembled within or onto the spray gun body. The spray gun body can also provide further assembly or operation mechanisms for additional parts or controls.

In a further exemplary embodiment, this disclosure is also directed to a nozzle for a liquid spray device. The nozzle includes:

a) a tubular nozzle body having an orifice (3) at a first end of the tubular nozzle body with an orifice diameter (3a), an inside diameter (2b) and a longitudinal rotational axis along the tubular nozzle body; and

b) a flow controller positioned inside the tubular nozzle body proximal to the first end having a rotational axis in coaxial alignment with the orifice (3) along the longitudinal rotational axis, the flow controller comprising a circular body (6) and a spray channel (7) therethrough with a backend opening (8) distal to the orifice (3) and a forward opening (9) proximal to the orifice (3), wherein the spray channel is tapered along the rotational axis, in a tapering distance (11), from the backend opening (8) having a backend opening diameter (8a) to the forward opening (9) having a forward opening diameter (9a).

The flow controller further comprises an extension channel (7′) having an extension channel diameter equal to the forward opening diameter, the extension channel is co-axial to the spray channel and positioned between the orifice and the spray channel. The extension channel can have an extension channel length in a range of from 10% to 120% of the tapering distance.

In an embodiment, the flow controller is a built-in flow controller with the circular body and the spray channel built in the tubular nozzle body. The flow controller can also be an add-on flow controller machined to fit the inside of the tubular nozzle body at the first end and affixed to the inside of the tubular nozzle body, the add-on flow controller can comprise the circular body (6) and the spray channel (7) therethrough the circular body.

This disclosure is further directed to a method for producing a dry coating layer over a substrate with a coating composition. The method comprises the steps of:

A) providing any of the liquid spray device of this disclosure; and

B) spraying the coating composition with the spray device to form a wet coating layer over the substrate.

The method can further comprise the step of:

C) curing the wet coating layer to form the dry coating layer.

The wet coating layer can be cured at ambient temperatures such as a temperature in a range of from 15° C. to 60° C., or at elevated temperatures, as a temperature in a range of from 60° C. to 200° C.

The nozzle of this disclosure provides better flow control. Traditional nozzles can have a steep increase in flow rate when the spray needle is pulled away from the closed position causing difficulty in controlling flow rate. The nozzles contemplated herein also provide an advantage of reducing spray needle being held by residual liquid, such as coating compositions, at the needle tip: the forward opening is configured to be larger than the orifice providing a break point for easy moving of the needle even in the presence of residual coating composition.

### EXAMPLES

The various embodiments are further defined in the following Examples. It should be understood that these Examples, while indicating preferred embodiments, are given by way of illustration only. From the above discussion and these Examples, one skilled in the art can ascertain the essential characteristics of the embodiments, and without departing from the spirit and scope thereof, can make various changes and modifications of the embodiments to adapt them to various uses and conditions.

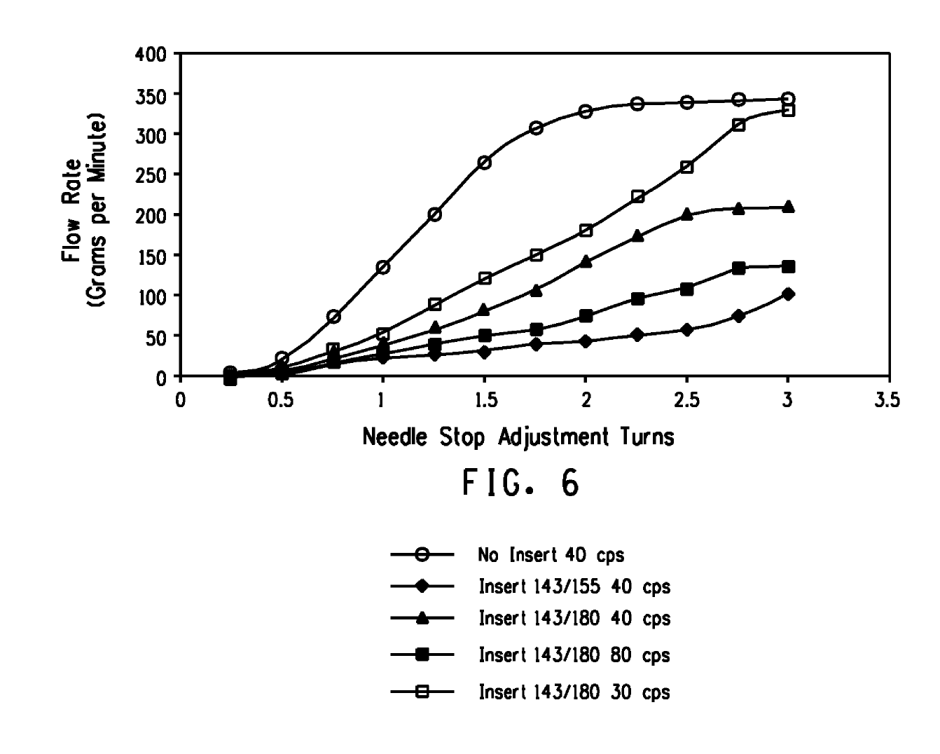

An add-on flow controller was machined using a steel block as shown in FIG. 3A with diameters of the backend opening and forward opening shown in Table 1. The add-on flow controller was inserted into a Satajet 3000 B RP spray gun with a nozzle orifice diameter of 1.8 mm. The spray gun is equipped with a needle stop adjustment to pre-set the needle travel distance. Each turn of the needle stop adjustment dial equals to 0.070 inch of linear needle travel distance. A sample coating composition DuPont™ Cromax® Pro, available under trademark and registered trademark from E. I. DuPont de Nemours and Company, Wilmington, Del., USA, was sprayed with or without the flow controller insert, at various coating viscosities as indicated. Data on spray flow rates are shown in Table 1 and plotted in FIG. 6. As shown, the nozzle having the flow controller (Exp 1-Exp 4) (various symbols) had improved flow control over the control (Comp 1) (Open Circle) (FIG. 6).

TABLE 1
Flow Rate Data (Grams per minute).

| | Exp 1 | Exp 2 | Exp 3 | Exp 4 | Comp 1 |
|---|---|---|---|---|---|
| | 40 cps⁽²⁾ | 80 cps⁽²⁾ | 40 cps⁽²⁾ | 30 cps⁽²⁾ | 40 cps⁽²⁾ |
| Turns⁽¹⁾ | 143/155⁽³⁾ | 143/180⁽³⁾ | 143/180⁽³⁾ | 143/180⁽³⁾ | No Insert |
| 0.25 | 5 | 0 | 2 | 0 | 6 |
| 0.5 | 11 | 5 | 12 | 11 | 20 |
| 0.75 | 16 | 14 | 26 | 34 | 70 |
| 1 | 21 | 24 | 42 | 57 | 130 |
| 1.25 | 24 | 37 | 60 | 89 | 200 |
| 1.5 | 28 | 50 | 83 | 119 | 270 |
| 1.75 | 34 | 62 | 109 | 148 | 310 |
| 2 | 37 | 72 | 139 | 180 | 325 |
| 2.25 | 47 | 93 | 177 | 223 | 334 |
| 2.5 | 60 | 109 | 200 | 263 | 335 |
| 2.75 | 75 | 133 | 213 | 313 | 337 |
| 3 | 101 | 135 | 215 | 325 | 339 |

⁽¹⁾Turns of the needle stop adjustment dial. One turn equals to 0.070 inch linear travel distance.
⁽²⁾Coating viscosity is Zahn Viscosity as determined using a #2 Zahn cup according to ASTM D 1084 Method D and then converted to centipoise using a conversion chart such as the Gardco Viscosity Cup Equivalent Chart from Paul N. Gardner Company, Inc.
⁽³⁾Forward opening diameter/backend opening diameter. Unit is 1/1000 of an inch.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A liquid spray device comprising:
a nozzle comprising:
a tubular nozzle body having an orifice at a first end of said tubular nozzle body with an orifice diameter, an inside diameter and a longitudinal rotational axis along said tubular nozzle body; and
a flow controller positioned inside said tubular nozzle body proximal to said first end having a rotational axis in coaxial alignment with said orifice along said longitudinal rotational axis, said flow controller comprising a circular body and a spray channel therethrough with a backend opening distal to said orifice and a forward opening proximal to said orifice, wherein said spray channel is tapered along said rotational axis, in a tapering distance, from said backend opening having a backend opening diameter to said forward opening having a forward opening diameter; and
a spray needle having a needle body with a seat diameter and a tapered needle tip with a maximum tip diameter equal to the seat diameter, wherein said spray needle is assembled therethrough said tubular nozzle body and said spray channel and is slidable along said longitudinal rotational axis between a closed position and a fully open position; wherein,
said backend opening diameter is greater than said seat diameter and smaller than the inside diameter, and the forward opening diameter is greater than the orifice diameter and smaller than the backend opening diameter, and
said spray needle is configured to position at the closed position to close said orifice, at the fully open position to open said orifice and fully open said spray channel, or at a position between the closed position and the fully open position to open said orifice and partially open said spray channel.

2. The liquid spray device of claim 1, wherein said flow controller is a built-in flow controller with said circular body and the spray channel built in the tubular nozzle body.

3. The liquid spray device of claim 1, wherein said flow controller is an add-on flow controller machined to fit the inside of said tubular nozzle body at said first end and affixed to the inside of the tubular nozzle body, said add-on flow controller comprising said circular body and the spray channel therethrough said circular body.

4. The liquid spray device of claim 1, wherein said backend opening diameter is in a range of from 110% of said seat diameter to 99% of said inside diameter and said forward opening diameter is in a range of from 101% of said seat diameter to 99% of said backend opening diameter.

5. The liquid spray device of claim 4, wherein said backend opening diameter is in a range of from 120% of said seat diameter to 99% of said inside diameter and said forward opening diameter is in a range of from 101% of said seat diameter to 90% of said backend opening diameter.

6. The liquid spray device of claim 1, wherein said flow controller further comprises an extension channel having an extension channel diameter equal to said forward opening diameter, and wherein said extension channel is co-axial to said spray channel and positioned between said orifice and said forward opening of the spray channel.

7. The liquid spray device of claim 6, wherein said extension channel has an extension channel length in a range of from 10% to 120% of said tapering distance.

8. The liquid spray device of claim 1, wherein said flow controller has a maximum controller flow-through area equal to or greater than the orifice flow-through area, wherein said maximum controller flow-through area is determined by said backend opening diameter and said spray needle at the fully open position, and wherein said orifice flow-through area is defined by said orifice diameter.

9. The liquid spray device of claim 8, wherein said liquid spray device is configured to have a variable spray flow rate between zero when the spray needle is at the closed position through a maximum flow rate when said spray needle is at the fully open position, and wherein said variable spray flow rate is controlled by a needle positioning device that positions said spray needle at variable positions within a needle travel range.

10. The liquid spray device of claim 9, wherein said needle travel range is equal to said tapering distance.

11. The liquid spray device of claim 9, wherein said spray needle is coupled to a trigger mechanism of the liquid spray device to slide said spray needle within said needle travel range between said closed position and said fully open position.

12. The liquid spray device of claim 10, wherein said needle positioning device comprises said trigger mechanism coupled to said spray needle, a needle adjustment device, or a combination thereof.

13. A method for producing a dry coating layer over a substrate with a coating composition, said method comprising the steps of:
providing a liquid spray device comprising:
a nozzle comprising:
a tubular nozzle body having an orifice at a first end of said tubular nozzle body with an orifice diameter, an inside diameter and a longitudinal rotational axis along said tubular nozzle body; and
a flow controller positioned inside said tubular nozzle body proximal to said first end having a rotational axis in coaxial alignment with said orifice along said longitudinal rotational axis, said flow controller comprising a circular body and a spray channel therethrough with a backend opening distal to said orifice and a forward opening proximal to said orifice, wherein said spray channel is tapered along said rotational axis, in a tapering distance, from said backend opening having a backend opening diameter to said forward opening having a forward opening diameter; and
a spray needle having a needle body with a seat diameter and a tapered needle tip with a maximum tip diameter equal to the seat diameter, wherein said spray needle is assembled therethrough said tubular nozzle body and said spray channel and is slidable along said longitudinal rotational axis between a closed position and a fully open position; wherein,
said backend opening diameter is greater than said seat diameter and smaller than the inside diameter, and the forward opening diameter is greater than the orifice diameter and smaller than the backend opening diameter, and
said spray needle is configured to position at the closed position to close said orifice, at the fully open position to open said orifice and fully open said spray channel, or at a position between the closed position and the fully open position to open said orifice and partially open said spray channel; and
spraying said coating composition with said liquid spray device to form a wet coating layer over said substrate.

14. The method of claim 13 further comprising the step of:
curing said wet coating layer to form said dry coating layer.

15. A substrate coated with the method of claim 13 or 14.

16. A nozzle for a liquid spray device, said nozzle comprising:
a tubular nozzle body having an orifice at a first end of said tubular nozzle body with an orifice diameter, an inside diameter and a longitudinal rotational axis along said tubular nozzle body; and
a flow controller positioned inside said tubular nozzle body proximal to said first end having a rotational axis in coaxial alignment with said orifice along said longitudinal rotational axis, said flow controller comprising a circular body and a spray channel therethrough with a backend opening distal to said orifice and a forward opening proximal to said orifice, wherein said spray channel is tapered along said rotational axis, in a tapering distance, from said backend opening having a backend opening diameter to said forward opening having a forward opening diameter.

17. The nozzle of claim 16, wherein said flow controller further comprises an extension channel having an extension channel diameter equal to said forward opening diameter, wherein said extension channel is co-axial to said spray channel and positioned between said orifice and said forward opening of the spray channel.

18. The nozzle of claim 16, wherein said extension channel has an extension channel length in a range of from 10% to 120% of said tapering distance.

19. The nozzle of claim 16, wherein said flow controller is a built-in flow controller with said circular body and the spray channel built in the tubular nozzle body.

20. The nozzle of claim 16, wherein said flow controller is an add-on flow controller machined to fit the inside of said tubular nozzle body at said first end and affixed to the inside of the tubular nozzle body, and wherein said add-on flow controller comprises said circular body and the spray channel therethrough said circular body.
